(19) United States
(12) Patent Application Publication
(10) Pub. No.: US 2012/0191829 A1
(43) Pub. Date: Jul. 26, 2012

(54) METHOD AND APPARATUS OF PERFORMING REMOTE REGISTRY CONFIGURATION

(75) Inventor: Derek Rodrigues, Ojai, CA (US)

(73) Assignee: KASEYA INTERNATIONAL LIMITED, St. Helier (VG)

(21) Appl. No.: 13/011,044

(22) Filed: Jan. 21, 2011

(51) Int. Cl. G06F 15/173

(52) U.S. Cl. 709/223

(57) ABSTRACT

Disclosed are an apparatus and methods of remotely managing a managed machine over a communication network. One example method of operation may include identifying the managed machine operating in a communication network and transmitting a connection establishment message to the managed machine over the communication network. In response, an acceptance message may be received from the manage machine. Once a secure channel has been established, the administrator may begin making changes to the registry configuration on the managed machine. The management operations may be performed from a browser-based application.

### TECHNICAL FIELD OF THE INVENTION

This invention relates to a method and apparatus of interacting remotely from a web application with a registry (i.e., Windows® Registry) of a managed machine, and, more particularly, to reading, writing and/or querying the registry of the managed machine over a network.

### BACKGROUND OF THE INVENTION

User workstations or managed machines (computing devices) operate in a data communication network by communicating with other managed machines and/or administrative machines. Regardless of the status of the machine, administrative machines operate to support the ongoing communication and applications operating on the managed machines.

Accessing and interacting with a managed machine through an administrative interface is a common method of updating, controlling, debugging and ensuring the continued seamless operation of the managed machine. However, certain challenges are presented with the advent of varying operating systems, control interfaces, and other commonalities of the managed machines operating on a data communication network. For example, various applications used by administrators to manage network computing devices often rely on a web-based browser application to engage the administrator with certain options and simple execution of administrative actions. In addition, feedback communication messages transmitted and received between the administrative machine and the managed machine(s) may require a secure connection and other communication features prior to authorizing administrative access to managed machines.

### SUMMARY OF THE INVENTION

One embodiment of the present invention may include a method of remotely managing a managed machine. The method may include identifying the managed machine operating in a communication network, and transmitting a connection establishment message to the managed machine over the communication network. Other operations of the method may include receiving an acceptance message from the manage machine, and rendering a view of the managed machine's registry remotely on a remote display device.

Another example embodiment of the present invention may include an apparatus configured to remotely manage a managed machine. The apparatus may include a transmitter configured to identify the managed machine operating in a communication network and transmit a connection establishment message to the managed machine over the communication network. The apparatus may also include a receiver configured to receive an acceptance message from the manage machine, and a processor configured to render a view of the managed machine's registry on a display device.

### BRIEF DESCRIPTION OF THE DRAWINGS

FIGS. 1A and 1B illustrate example network configurations, according to example embodiments of the present invention.

FIG. 2 illustrates an example application communication session, according to an example method of operation of the present invention.

FIG. 3 illustrates a flow diagram of an example method, according to example embodiments of the present invention.

FIG. 4 illustrates an example graphical user interface (GUI) administrator web application according to an example embodiment of the present invention.

FIG. 5 illustrates an example network entity device configured to store instructions, software, and corresponding hardware for executing the same, according to example embodiments of the present invention.

### DETAILED DESCRIPTION OF THE INVENTION

It will be readily understood that the components of the present invention, as generally described and illustrated in the figures herein, may be arranged and designed in a wide variety of different configurations. Thus, the following detailed description of the embodiments of a method, apparatus, and system, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present invention, the invention may be applied to many types of network data, such as, packet, frame, datagram, etc. For purposes of this invention, the term “message” also includes packet, frame, datagram, and any equivalents thereof. Furthermore, while certain types of messages and signaling are depicted in exemplary embodiments of the invention, the invention is not limited to a certain type of message, and the invention is not limited to a certain type of signaling.

According to example embodiments of the present invention, an administrator may be any information technology (IT) system administrator, IT service provider, and/or computer owner/operator that provides administrative functions to the computer devices, connections and other network resources. A managed machine may be any network-connected computer device managed by the administrator. The managed machines may be connected directly to the administrator's machine, or, over a network connection.

An administrator application may be a web-based application that permits the administrator to manage one or more remote managed machines. A secure network channel may be setup and established between the administrator machine and the remote managed machine via the administrator application. The secure network channel may provide connections over which data packets may be exchanged. The network channel may pass through a wide area network (WAN) (e.g. the Internet) or through a private local area network (LAN).

A server process may be an application that includes a process running on the remote managed machine. The server process accepts connections from the administrator application and assists with setting up a channel and transmitting and receiving commands and data. An administrator plug-in may be a browser plug-in operating in the context of the administrator application that connects with and interacts with the server process over the existing network channel.

When modifying a computer's registry, many programs including Microsoft Windows® system processes use the registry (i.e., Windows® Registry) to store configuration data that controls behavior. Advanced users, such as administrators, may occasionally need to modify the behavior of these programs by updating the registry. Changes to the registry might include the insertion of new keys/values, and/or the updating of existing keys/values. Generally, an administrator interacts with the registry by using the Windows Registry Editor.

According to example embodiments of the present invention, having the capability to remotely modify the registry of a remotely managed computer provides the administrator with increased flexibility by not requiring physical presence at the physical console or the need to remotely take-over or enter the operating environment of the user's managed machine. Such conventional administrative actions may limit the interoperability of performing maintenance procedures.

Remote registry dispatching of registry operations may include dispatching commands, such as, browse, create, read, and write on keys and/or values. Also, the installation of a remote-control connect session product onto the user interface browser is an example of an interaction with the registry and/or registry command. For instance, such a remote-control connect session may include adding keys and values to the registry in an effort to register itself as a plug-in of a web browser (i.e., Internet Explorer®). In addition, keys/values may also be added to inform the browser application that it may need to launch a process from the browser and that this process will require certain permissions. Internet Explorer is an example of an application that knows to look for these values in the registry.

The interaction with the registry may be automated or manual. The registry operations may be transmitted over a network from a web application to a target machine operating on a private network. The operations may be transmitted through a secure channel that is established between the web application host computer and the target machine or client computer. Output may be sent back through the same secure channel from the client computer to the web application host machine. As a result of this configuration, the administrator is provided with the functionality of the Windows Registry Editor program without having to take-over the operation of the managed machine or access the physical console.

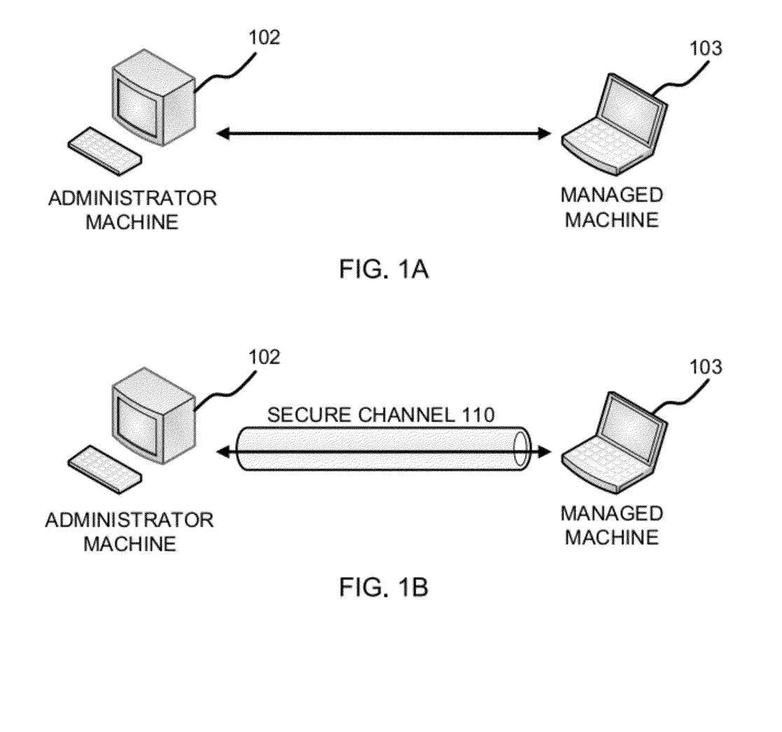

FIG. 1A illustrates an example network communication path between a managed machine and an administrator machine, according to example embodiments of the present invention. Referring to FIG. 1A, an administrator machine 102 is in communication with a managed machine 103. The communication path may be over a WAN, such as, the Internet, or a LAN. The administrator machine 102 may be a server, computer or other computing device capable of providing a user interface. The managed machine 103 may be a laptop, computer, personal digital assistant, smart phone or any other computer network compatible device capable of establishing a communication path or secure channel 110 with the administrator machine 102.

FIG. 1B illustrates an example network communication path between a managed machine 103 and administrator machine 102 that includes an established secure channel 100, according to example embodiments of the present invention. Referring to FIG. 1B, the administrator initiates a connection via a secure channel to the remote managed machine 103. The server process running on the managed machine accepts and acknowledges the connection establishment by transferring an acceptance message back to the administrator application. A secure connection may then be established between the managed machine 102 and the administrator machine 102. This process is discussed in further detail below.

In operation, the remote interaction performed by the administrator machine 102 with the registry of the managed machine 103 is transparent to the user of the managed machine 103, and generally will not disrupt the current user's computer activities. For example, a corresponding agent process configured to manage the registry of the managed machine is already running as a background service on the managed machine 103, and has a low memory/CPU footprint. The user can continue to perform work and/or other tasks concurrent with the execution of the remote registry management process.

Once registry access is established by the administrator, the agent process responsible for maintaining the registry access process will have loaded and/or launched additional binaries related to the relay connection of the secure connection 110 and the registry service. Upon execution, the binaries will spawn additional threads that will likely only consume a trivial amount of system resources (i.e., CPU, memory, etc.). The registry operations are performed in the ‘background’, which are transparent to any user operating at their respective console.

One example method of initiating registry functions from an administrator application to a managed machine 103 is described in detail below. An administrator may initiate a registry function of an administrator application for a particular managed machine 103. The administrator application may be a browser-based web application and may include a plug-in which initiates a connection via an already established and secure relayed channel or a point-to-point (P2P) channel to the remote target machine.

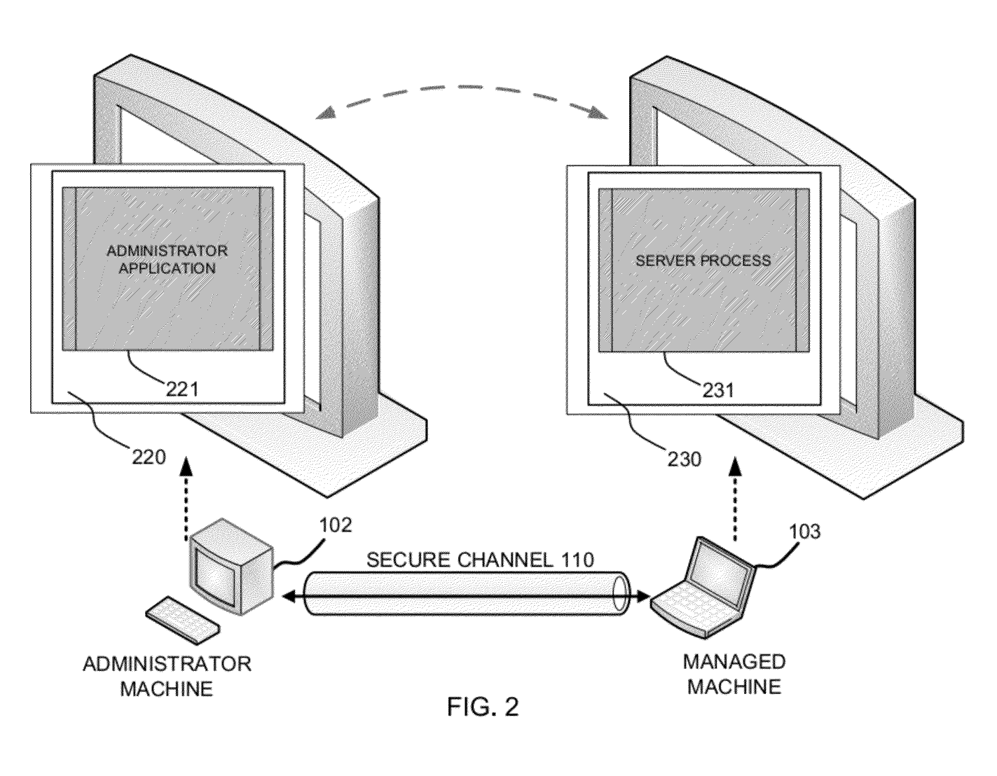

Referring to FIG. 2, the server process 231 running on the managed machine 103 accepts and acknowledges the connection attempt by the administrator application 221. As a result, the administrator application 221 renders a view of the registry on the web application 220 including a fixed subset of the root keys. For example, access may be provided to root keys, such as, HKEY_LOCAL_MACHINE, HKEY_USERS, and HKEY_CURRENT_CONFIG. As a result, the administrator may perform remote registry operations within the scope of the above-noted root keys. For instance, the administrator may browse the registry hierarchy on the administrator's user interface 220 to perform certain registry operations.

Examples of registry operations may include, for example, “expand keys”—which returns all immediate descendents of a given key, “find keys/values”—which performs a search of a sub-tree for a given key name or value, “read keys/values”—which show the values associated with a given key, “create new keys”—which creates new child keys, “delete keys/values”—which deletes existing keys or values, and “rename keys/values”—which updates values.

Each interaction and/or operation performed with respect to the managed machine's registry may result in a round-trip from the administrator application 221 and the server process 231 of the managed machine 103 over the secure channel 110. The registry operations are executed by the server process and the results of the operation are returned back to the administrator plug-in.

Each browser (e.g., Internet Explorer, Firefox, Chrome, etc.) has its own plug-in architectures. Regardless of the architectures, the plug-ins are implemented as DLLs that implement a specific interface (required by the browser) and are “registered” with the browser. The browser may then load these plug-ins upon the request of client-side JavaScript code running in the browser in the context of a web page. The JavaScript code can then interact with the plug-in to perform a function(s) that the plug-in exposes. For instance, the JavaScript code may invoke methods or read properties of the plug-in. The plug-in code is binary executable code that is loaded within the process space of the browser, and can perform any of variety of different functions. Plug-ins can be signed by the publisher (e.g. Kaseya) as a way of reassuring the user their communication session is secure.

The server process 231 acts as a delegate to the administrator on the managed machine 103. For example, in a Windows environment, the Windows application programming interface (API) calls to execute the operations requested by the administrator 102. Communications between the administrator's browser 220 and the server process 231 are exchanged over Internet using a proprietary messaging protocol, such as, JSON formatted messages. The messages may be encrypted using the AES symmetric key encryption algorithm and then prefixed with a binary header containing a byte count and a message identifier (indicating what type of message is enclosed).

The server process 231 manages the transfer and adaptation of the Unicode string formats exchanged between the browser-based administrator application and the server process operating on the managed machine. For example, by default, most browsers use UTF-8 text encoding, which may not be the same encoding used by the command prompt on the managed machine 103, and, thus a mapping and/or translation must be performed prior to executing the operation.

The interactions (commands and responses) may be encoded using the JavaScript Object Notation (JSON) format, which is a format readily supported and interpreted by the JavaScript browser-based web client. The messages transmitted and received are encrypted using AES between the two endpoints. Having a reliable agent process already installed on the managed machine 103 (i.e., the server process 231), which has local system account privileges, enables seamless administrative maintenance. In addition, the server process communicates with the administrative machine 102 via an already established communication channel. The established secure channel 101 may be used to bootstrap the registry session before using the relay connection or peer-to-peer connection.

A method of establishing a connection and initiating a session between the administrator 102 and the managed computer 103 is disclosed below. At the administrator's prompting, the browser initiates a remote-control connect session with the web server, and the server or administrator machine 102 delivers binaries to the agent (i.e., server process) on the managed machine 103. The administrator machine 102 instructs the server process to launch the binaries. A relay connection is established between the administrator machine 102 and the managed machine 103 with a corresponding peer on the browser. A connection is initiated from the browser, and the connection is accepted and the registry service (i.e., binary) is initiated by the server process 103 to process commands.

According to example embodiments of the present invention, the registry operations are provided to the administrator remotely in the context of a remote-control connect session that must be established in order to supply operation data to the existing managed machine 103 with a pre-installed agent (i.e., server process 231. The registry commands and their corresponding responses are encoded as JavaScript object notation messages (JSON), which are used to represent simple data structures and associative arrays or objects. JSON is language-independent and uses parsing which provides interoperability of different programming languages and their corresponding operating environments. The JSON messages are created and sent over transmission control protocol (TCP) using a relayed or P2P connection. The messages are exchanged over the existing channel established by an agent, server, and/or browser.

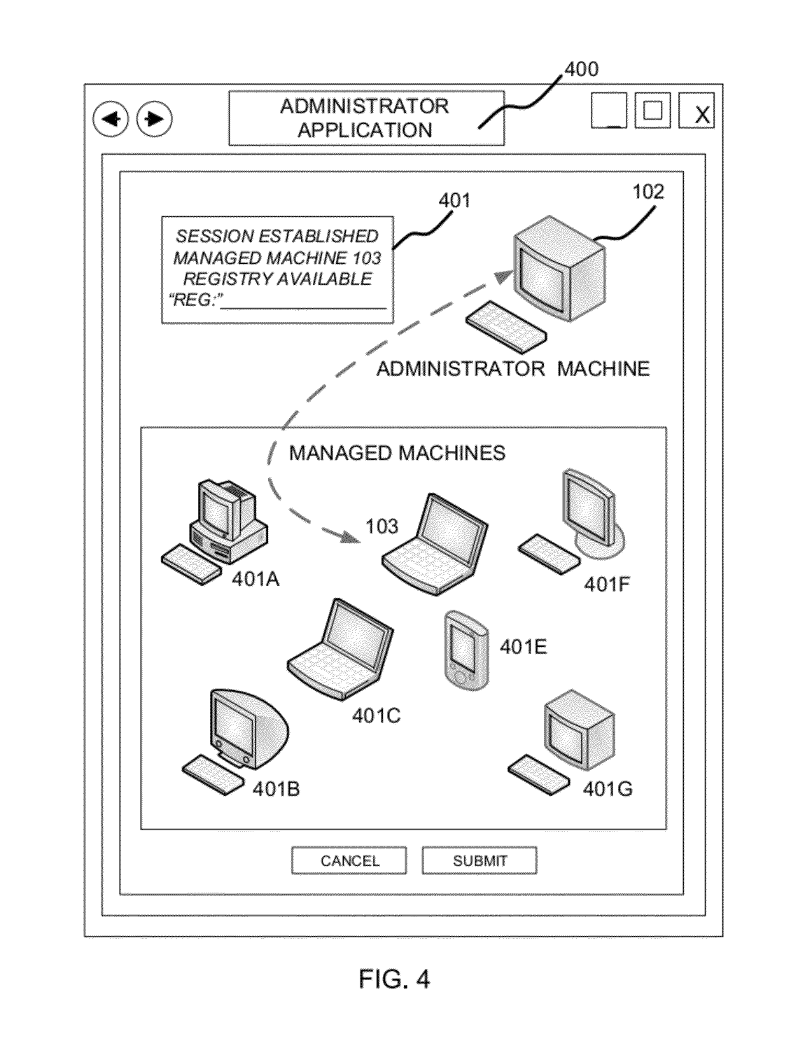

FIG. 4 illustrates an example GUI that may be used by the administrator to access the registry, according to example embodiments of the present invention. Referring to FIG. 4, the administrator application 400 provides an interface to view the administrator machine 400 and the various network components of the managed network (103, 401A-401G, etc.). The administrative network configuration may provide support for all types of managed machines. For example machines 401A-401G includes examples of computers, laptops, PDAs, tablet PCs, smart phones, etc., each of which may be capable of establishing a network connection to the administrator server and receiving support from the remote command prompt. After a secure connection and authorization has been established to a managed computer 103, the command prompt 401 may appear as a window on the administrator's GUI space, which may be used to enter registry operations directly.

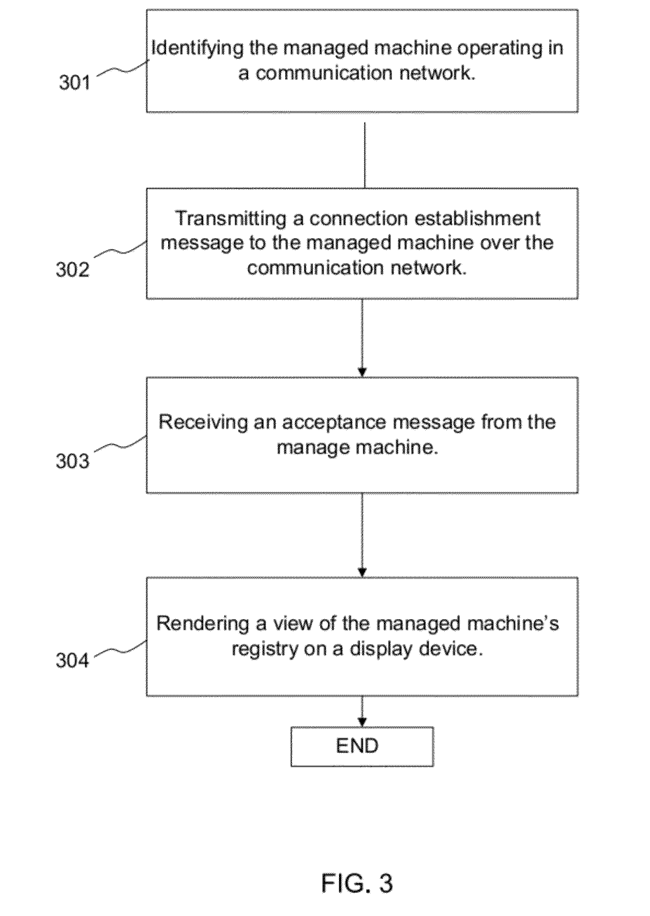

One example method of remotely managing a managed machine operation is illustrated in the flow diagram of FIG. 3. Referring to FIG. 3, the method may include identifying the managed machine operating in a communication network, at operation 301. The method may also include transmitting a connection establishment message to the managed machine over the communication network, at operation 302, and receiving an acceptance message from the managed machine, at operation 303. The method may also include rendering a view of the managed machine's registry across the communication network, at operation 304.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

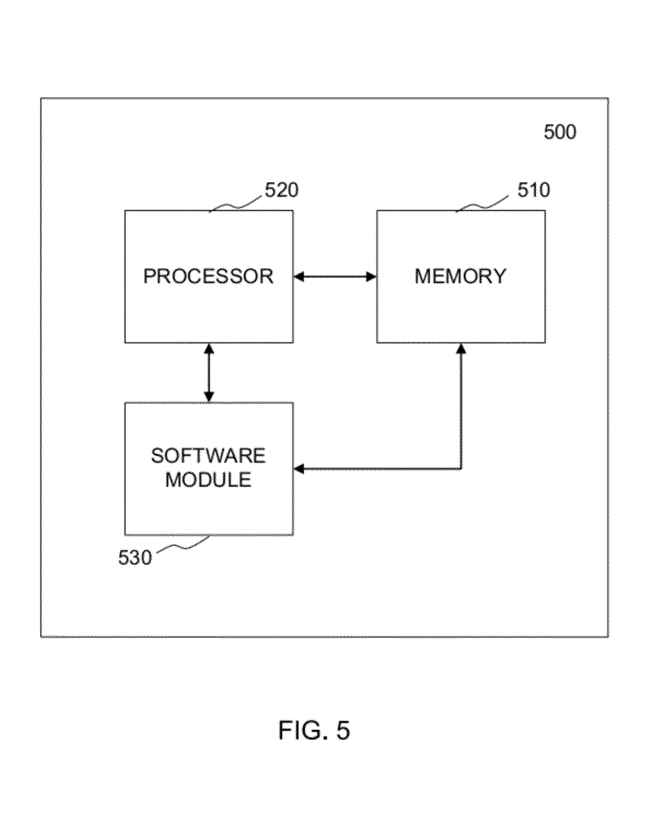

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example FIG. 5 illustrates an example network element 500, which may represent any of the above-described network components 102, 103 and 401.

As illustrated in FIG. 5, a memory 510 and a processor 520 may be discrete components of the network entity 500 that are used to execute an application or set of operations. The application may be coded in software in a computer language understood by the processor 520, and stored in a computer readable medium, such as, the memory 510. The computer readable medium may be a non-transitory computer readable medium that includes tangible hardware components in addition to software stored in memory. Furthermore, a software module 530 may be another discrete entity that is part of the network entity 500, and which contains software instructions that may be executed by the processor 520. In addition to the above noted components of the network entity 500, the network entity 500 may also have a transmitter and receiver pair configured to receive and transmit communication signals (not shown).

It is to be understood that the above description is intended to be illustrative, and not restrictive. Many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. A method of remotely managing a managed machine, the method comprising:
identifying the managed machine operating in a communication network;
transmitting a connection establishment message to the managed machine over the communication network;
receiving an acceptance message from the manage machine; and
rendering a view of the managed machine's registry on a display device.

2. The method of claim 1, wherein transmitting a connection establishment message to the managed machine comprises an administrator plug-in application initiating the connection establishment message via a secure channel to a server process executing on the remote managed machine.

3. The method of claim 2, wherein the transmitted connection establishment message is received at a server process executing on the managed machine.

4. The method of claim 1, further comprising:
performing at least one registry operation comprising at least one of expanding keys, finding keys, reading keys, creating keys, deleting keys, renaming keys and updating keys in the managed machine's registry.

5. The method of claim 1, further comprising:
terminating the view of the managed machine's registry after a predetermined period of time if no registry operation is received.

6. The method of claim 1, further comprising:
receiving output from the server process as a result of the registry operation being executed on the managed machine.

7. The method of claim 6, wherein communications transmitted to and received from the managed machine are performed over the Internet using JavaScript object notation (JSON) formatted messages.

8. An apparatus configured to remotely manage a managed machine, the method comprising:
a transmitter configured to identify the managed machine operating in a communication network and transmit a connection establishment message to the managed machine over the communication network;
a receiver configured to receive an acceptance message from the manage machine; and
a processor configured to render a view of the managed machine's registry on a display device.

9. The apparatus of claim 8, wherein the processor further comprises an administrator plug-in application configured to initiate the connection establishment message via a secure channel to a server process executing on the remote managed machine.

10. The apparatus of claim 9, wherein the transmitted connection establishment message is received at a server process executing on the managed machine.

11. The apparatus of claim 8, wherein the processor is further configured to perform at least one registry operation comprising at least one of expanding keys, finding keys, reading keys, creating keys, deleting keys, renaming keys and updating keys in the managed machine's registry.

12. The apparatus of claim 8, wherein the processor is further configured to terminate the view of the managed machine's registry after a predetermined period of time if no registry operation is received.

13. The apparatus of claim 8, wherein the processor is further configured to receive output from the server process as a result of the registry operation being executed on the managed machine.

14. The apparatus of claim 13, wherein communications transmitted to and received from the managed machine are performed over the Internet using JavaScript object notation (JSON) formatted messages.

15. A non-transitory computer readable storage medium configured to store instructions that when executed cause a processor to perform remote management of a managed machine, the processor being further configured to perform:
identifying the managed machine operating in a communication network;
transmitting a connection establishment message to the managed machine over the communication network;
receiving an acceptance message from the manage machine; and
rendering a view of the managed machine's registry on a display device.

16. The non-transitory computer readable medium of claim 15, wherein transmitting a connection establishment message to the managed machine comprises an administrator plug-in application initiating the connection establishment message via a secure channel to a server process executing on the remote managed machine.

17. The non-transitory computer readable medium of claim 16, wherein the transmitted connection establishment message is received at a server process executing on the managed machine.

18. The non-transitory computer readable medium of claim 15, wherein the processor is further configured to perform:
performing at least one registry operation comprising at least one of expanding keys, finding keys, reading keys, creating keys, deleting keys, renaming keys and updating keys in the managed machine's registry.

19. The non-transitory computer readable medium of claim 15, further comprising:
terminating the view of the managed machine's registry after a predetermined period of time if no registry operation is received.

20. The non-transitory computer readable medium of claim 15, further comprising:
receiving output from the server process as a result of the registry operation being executed on the managed machine.
